(19) United States
(12) Patent Application Publication
(10) Pub. No.: US 2005/0176568 A1
(43) Pub. Date: Aug. 11, 2005

(54) Shuttle pouch machine

(75) Inventors: Gerald R. Winiecki, Suring, WI (US); Randal C. Wied, Green Bay, WI (US); Gary F. Sargin, Green Bay, WI (US)

Correspondence Address: GEORGE R CORRIGAN, 5 BRIARCLIFF COURT, APPLETON, WI, 54915, US

(73) Assignee: CMD

(21) Appl. No.: 11/046,077

(22) Filed: Jan. 27, 2005

Related U.S. Application Data
(63) Continuation of application No. 10/279,764, filed on Oct. 23, 2002, now abandoned.

(51) Int. Cl. B31B 49/04

(52) U.S. Cl. 493/189

(57) ABSTRACT

A method and apparatus for making pouches is disclosed. It includes continuously moving the film through an intake section and then through a shuttle section. The film passes a plurality of successive sealing stations in the shuttle section, and while the film moves continuously, the film is at times generally stationary with respect to the sealing stations and at times moving with respect to the sealing stations. A plurality of successive seals is applied with the plurality of sealing stations, while the film is generally stationary with respect to the sealing stations. The film is then moved through an output section.

### FIELD OF THE INVENTION

The present invention relates generally to the art of bag making. More specifically, it relates to forming pouches from film.

### BACKGROUND OF THE INVENTION

Pouch making machines generally advance a film and use a heated seal station to apply (form) a seal to the film. When the seals are being applied the film is stationary with respect to the sealing station.

Prior art machines provide the relative non-movement in one of several ways. Intermittent motion machines advance the film, stop the film and apply the seal while the film is stopped. They then repeat the process for succeeding pouches. The speed of this type of machine is limited by the time it takes to accelerate and decelerate the film. This also creates tension spikes on the film. Even if the tension is overcome, the speed is limited by the time it takes to make one seal. Since it often takes 0.5-1 second to make a seal, the absolute maximum production such a machine could obtain (with infinite speed) is 120 pouches per lane per minute (additional lanes or additional pouches across the machine direction are expensive, and printed film is often limited to 40 inches wide).

One prior art system shown is in U.S. Pat. No. 6,024,683 to Wilkes (incorporated by reference) and overcame the single seal per cycle problem by providing successive multiple sealing units (each for sealing one pouch). Then, when the film is stopped, a plurality of pouches are made in each lane. However, such a system did nothing to alleviate tension spikes from acceleration/deceleration.

Prior art machines for bag making (other than pouches) included rotary drum sealers, such as that shown in U.S. Pat. No. 4,934,993 to Gietman, direct the film around the surface of a drum that rotates at a circumferential speed equal to the film speed. Thus, while the film moves with the drum, it is stationary with respect to the drum surface. Retractable seal bars form the seals. Using this system it is difficult to adjust the seal relative to a registration mark, and is not well suited for pouch machines.

Another type of prior art system (not used specifically for pouch machines) is based on a shuttle design and is shown in U.S. Pat. No. 3,322,604 to Schott (incorporated by reference). It provides reciprocating movement of the sealing stations along the film path—with the film and opposite the film. While the sealing stations are moving with the film there is not movement of the film relative to the stations, so the heat seal may be applied. After the seal is formed, the movement is in the upstream direction, and the shuttle resets for the next cycle. Such a system, while avoiding acceleration/deceleration stresses on the film, is still limited by the time it takes to make a seal, since there is only one pouch sealed per cycle per lane.

Accordingly, a pouch machine that makes multiple pouches per cycle (per lane) is desirable. Preferably it will also avoid acceleration/deceleration stresses on the film.

### SUMMARY OF THE PRESENT INVENTION

According to a first aspect of the invention a pouch machine includes a continuous motion intake section that a film path passes through, a shuttle section, and an output section. The shuttle section is downstream of the intake section and includes a plurality of successive sealing stations, each disposed along the film path. The film path passes through the shuttle section, and while the film moves continuously, the film is at times generally stationary with respect to the sealing stations and at times moving with respect to the sealing stations. The output section is located downstream of the shuttle section, and the film path passes through the output section.

According to a second aspect of the invention a method of making pouches from a film includes continuously moving the film through an intake section and then through a shuttle section. The film passes a plurality of successive sealing stations in the shuttle section, and while the film moves continuously, the film is at times generally stationary with respect to the sealing stations and at times moving with respect to the sealing stations. A plurality of successive seals is applied with the plurality of sealing stations, while the film is generally stationary with respect to the sealing stations. The film is then moved through an output section.

A continuous motion outfeed servo-driven nip is disposed to between the shuttle section and output section, and/or a servo driven nip is provided between the intake and shuttle section in various embodiments.

The output section includes a continuous motion section with a registration station and a knife, such as a rotary die cutter, in other embodiments.

The output section includes a stacking station in another embodiment.

The intake section includes one or more of a folding station, such as a dual VEE folder, a punch station, a registration station, and an unwinding station in various alternatives.

The shuttle section includes a registration station in one embodiment.

The sealing stations include three, four or more platen sealing modules in some embodiments.

The shuttle section includes a shuttle in roll upstream of the sealing stations and a shuttle out roll downstream of the sealing stations in another embodiment.

The shuttle section includes a carriage, on which the shuttle in and shuttle out rolls are mounted in yet another embodiment. The shuttle section also includes a motor that moves the carriage generally in the downstream direction, and generally in the upstream direction.

The sealing station are mounted on the carriage in another embodiment.

The speed the carriage moves downstream is about one-half the film speed in some embodiments.

Other principal features and advantages of the invention will become apparent to those skilled in the art upon review of the following drawings, the detailed description and the appended claims.

### BRIEF DESCRIPTION OF THE DRAWINGS

FIG. 1 is a diagram of a pouch machine in accordance with the present invention; and

FIG. 2 is a diagram of a shuttle section in accordance with the present invention.

Before explaining at least one embodiment of the invention in detail it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting. Like reference numerals are used to indicate like components.

### DETAILED DESCRIPTION OF THE PREFERRED EMBODIMENTS

While the present invention will be illustrated with reference to particular machines, designs, and sections, used to make a particular pouch, it should be understood at the outset that the invention can also be implemented with other machines, sections, designs, and can produce other products.

The invention generally includes a shuttle section with multiple successive sealing stations, for forming successive seals simultaneously. The preferred embodiment provides that the shuttle section include four platen sealing stations. Section or station, as used herein, includes a portion of a machine that senses or performs one or more operations on the film. Successive sealing stations, as used herein, includes sealing station that apply seals to successive pouches in the machine direction. Successive seals, as used herein, includes seals on successive pouches in the machine direction.

The drives are preferably servo-driven, and the machine includes an intake and an output section for providing the film to, and taking the film from, the shuttle section. Servo-driven, as used herein, includes a nip or device controlled at least in part by a servo motor. The preferred embodiment uses servo drives in each section, and thus provides three individual tension zones. It also includes three separate print registration zones to provide better registration control.

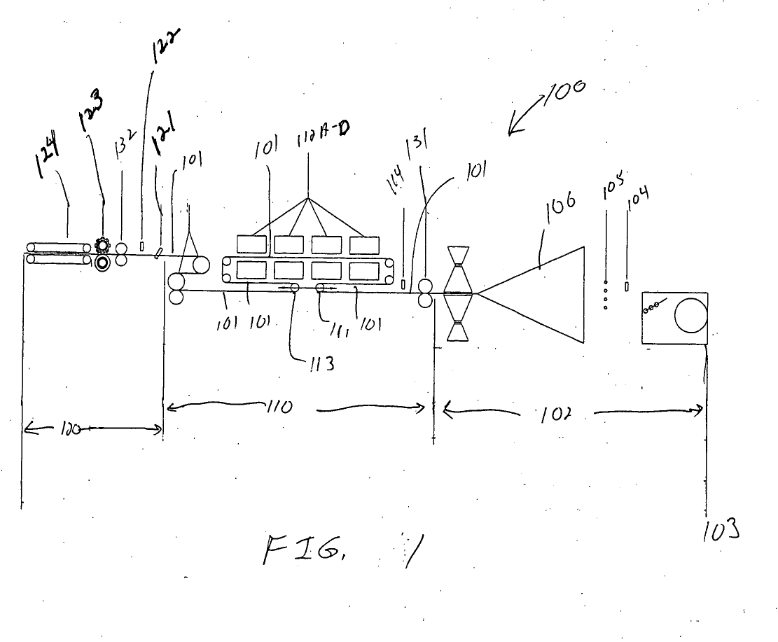

Referring now to FIG. 1, a pouch machine 100 in accordance with the present invention has a film path 101 extending through an intake section 102, a shuttle section 110 and an output section 120.

Intake section 102 is preferably a continuous motion section, and includes an unwind station 103, a registration station 104, a punch station 105 and a folding station 106. Intake section, as used herein, includes a section of the machine upstream of the shuttle section, and can be either adjacent the shuttle section, or another section can be therebetween. Continuous motion section, as used herein, includes a section in which the film moves continuously along the film path.

The unwind station is preferably a driven unwind station to provide tension control and reduce scrap by holding gussets in place more consistently and reducing film weave. The folding station is preferably a 2-Up V-folding module that provides for simultaneously folding and gusseting two lanes of material from a single web. Continuous web flow maintains proper film tension for consistent folding and gusseting for reduced scrap. The preferred punch station includes ball and die punching for clean hole punches in registration (via registration station 104) with the print.

The film passes from input section 102 through a servo drive nip 131 to shuttle section 110. Shuttle section 110 includes a roll 111, a plurality of sealing stations 112A-D, a roll 113, and a registration station 114. Shuttle section, as used herein, includes a section of a machine that provides for reciprocating movement of at least a part of the shuttle section, wherein the movement is generally in the downstream and upstream film directions

Sealing stations 112A-D are disposed along film path 101 such that they can a form the seals in the film. Along the film path, as used herein, means close enough to the film path to perform the desired operation.

Sealing stations 112A-D are preferably multiple platen sealers (at least two, and three or four in various embodiments) that provide the ability to seal several successive pouches at the same time during one machine cycle. Therefore, multiple seals can be made at the same time and can keep the machine cycle rates fairly low with more seal dwell time available for maximum production. For example, with four successive sealing stations, a two-lane machine running 75 cycles per minute will produce 600 pouches per minute through the sealing section of the machine. Each sealing station 112A-D preferably applies multiple seal hits on each pouch including one gusset seal, one gusset transition spot seal and two cross seals. The preferred sealing station includes three, 20″ metal-to-metal gusset sealer, metal-to-rubber and rubber-to-metal platen sealers, with multi-zone heated upper and lower head insure consistent seal temperatures for all seals. The seal head is capable of reaching 500° F. adjacent to the die and 250° F. adjacent to the rubber.

Rolls 111 and 113 are mounted on a carriage which is moved by a servo motor, such that rolls 111 and 113 move reciprocally in the directions of the arrow. When rolls 111 and 113 are moved to the left (at a speed of about one half the film speed) the film under sealing stations 112A-D is generally stationary with respect to sealing stations 112A-30 D. Thus, during this time the seals are applied. About one half the film speed, as used herein, includes a speed sufficiently close to one half to allow the seals to be formed. Generally stationary with respect to the sealing stations, as used herein, includes sufficiently little relative movement that the seals may be formed.

Then, rolls 111 and 113 are moved back to the right to rest for the next cycle. Each cycle four successive pouches are sealed in the preferred embodiment, but other numbers of pouches are sealed each cycle in other embodiments.

The carriage is moved by other motors in other embodiments. Carriage, as used herein, includes a moveable structure on which portions of the machine are mounted. Motor, as used herein, includes servo motors, electric motors, hydraulic motors, linear motors, or anything else that can move the carriage.

The shuttle section provides smooth web handling by providing a continuous web flow into and out of the sealing area. This eliminates the web tension spikes caused by intermittent motion machine and helps provide accurate registration of the seals to the print. The preferred AC servo controlled dwell time allows for control of the seal conditions to help repeatability of performance for each pouch.

The film leaves shuttle section 100 through a servo driven nip 132, and is then provided to output section 120. The separate intake (131) and outfeed (132) AC servo driven nip allow for web tension control and for improved web tracking. Nip 132 may be water cooled to cool the film after sealing. A load cell roll may be provided for providing tension feedback to control outfeed nip drive for maintaining constant web tension throughout the sealing section.

Output section 120 includes a trimming station 121, a registration station 122, a servo drive nip 122, a cutting station 123 and a stacking station 124. Trimming station 121 preferably includes a razor knife that is adjustable to allow for correct slitter positioning for separating multiple lanes and for trimming,

Cutting station 123 includes a knife (anything that cuts or perforates the film). Preferably it includes a rotary die cutter with replaceable cutting dies. Servo driving the die roll allows registration of the cut off on each pouch by making a slight position correction of the die roll between each die cut.

A continuous flow of pouches is transferred from the die cutter to stacking station 124 so the pouches can be grouped in batches and transferred to the pouch erecting equipment.

Overall, the machine uses seven servos to provide drive power for machine motion. Three separate zones of tension control are created by servo driven nips. This provides for independently controlled tension and registration through each section in the preferred embodiment. The machine is configured in a modular style with plug-and-play convenience, This allows flexibility to accommodate different product specification changes. Each module or station or section in the machine is mechanically and electrically independent from other modules. All control signals are carried from section to section by a quick-connect fiber optic cable.

A user-friendly touch screen operator interface provides for digital selection of most machines set up parameters. Seal dwell, seal temperatures and cycle rates can be entered through the operator interface and changed on the fly.

The machine described herein provides many advantages, including single sheet construction which eliminates the need for separate rolls of material for top, bottom and inserted gusset of pouches, print registration of front, back and gussets of pouch, an edge sensor to control web steering to precisely align the web through the cutting station, and easy set up and adjustability for various pouch sizes reduces set up time and increases productivity. These advantages are not all needed to practice the invention, and various embodiments incorporate less than all of these features.

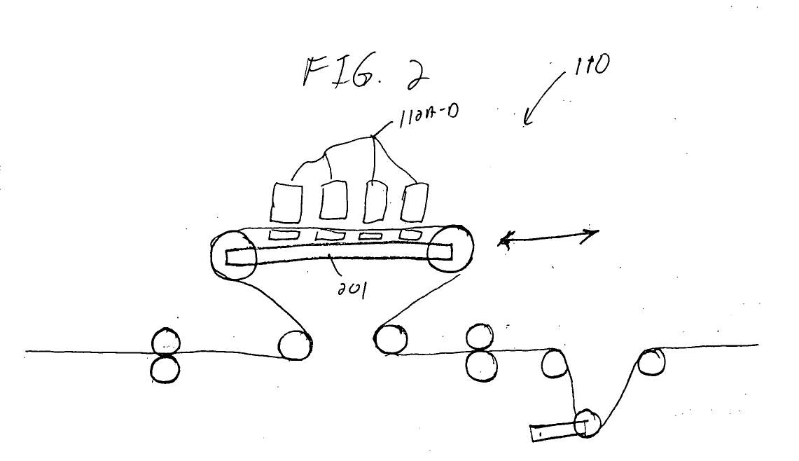

One alternative shuttle section is shown in FIG. 2, and includes a carriage 201, on which sealing station 112A-D are mounted. Carriage 201 is reciprocally moved in the direction of the arrow. Thus, the sealing stations are moved with and opposite the film.

Other embodiments include other sections before and after the shuttle section, intermittent section, multiple moving rolls, wherein the speed of the shuttle can be ¼ or less the speed of the film.

Numerous modifications may be made to the present invention which still fall within the intended scope hereof. Thus, it should be apparent that there has been provided in accordance with the present invention a method and apparatus for a pouch machine that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

1-47. (canceled)

48. A method for applying seals to form a pouch from a film, comprising:
continuously moving the film;
moving a carriage generally in the downstream direction such that at least three successive sealing stations are generally stationary with respect to the film;
while the carriage is moving in the downstream direction forming a plurality of successive seals with the plurality of sealing stations; and
moving the carriage generally in the upstream direction such that the carriage moves with respect to the film.

49. The method of claim 48, wherein moving the carriage in the downstream direction includes moving the carriage at a shuttle speed and the film moves continuously at a film speed, and the shuttle speed is about one-half the film speed.

50. A machine for applying seals to form a pouch from a film, comprising:
means continuously moving the film along a film path;
means for forming a plurality of successive seals, wherein the means for forming are disposed along the film path, and mounted on a carriage including at least 3 platen sealing modules; and
means for moving the carriage generally in a downstream direction such that the means for forming are generally stationary with respect to the film while the carriage is moving in the downstream direction, and for moving the carriage generally in the upstream direction such that the carriage moves with respect to the film.
